(19) United States
(12) Patent Application Publication
(10) Pub. No.: US 2005/0200862 A1
(43) Pub. Date: Sep. 15, 2005

(54) Method and device for controlling objects in synchonicity with a moving material web

(75) Inventor: Volker Schoenfeld, Guetersloh (DE)

Correspondence Address: Bill R. Naifeh, Suite 1014, LB 55, 12655 N. Central Expressway, Dallas, TX, 75243, US

(73) Assignee: eltromat GmbH, Leopoldshohe (DE)

(21) Appl. No.: 11/031,446

(22) Filed: Jan. 7, 2005

(30) Foreign Application Priority Data
Jan. 8, 2004 (DE) 10 2004 001 338.1

(51) Int. Cl. G06F 15/00

(52) U.S. Cl. 358/1.5

(57) ABSTRACT

The invention relates to a method for controlling objects in synchronicity with a moving material web comprising the following method steps: Printing a mark pattern onto the material web, the mark pattern consisting of elements having different brightness values and/or color contrasts and being arranged one behind the other in the web travel direction; detecting the differences in brightness and/or color contrast existing as a result of the printed mark pattern in the web travel direction for the purpose of identification; comparing the mark pattern that is printed on the material web and is detected to a predetermined mark pattern; and emitting a control signal according to the result of the comparison carried out.

### CROSS REFERENCE TO RELATED APPLICATIONS

This application claims the benefit of the filing date of the German Patent Application No. 10 2004 001 338.1, filed on Jan. 8, 2004, the disclosure of which is incorporated herein by reference.

### TECHNICAL FIELD

The invention relates in general to printing methods and machines, and in particular to a methods and devices for controlling objects in synchronicity with a moving material web.

### BACKGROUND INFORMATION

Such an object or such a series of objects that are to be controlled in synchronicity with a moving material web with high accuracy may be, for example, an observation of a moving print web by means of a video camera in which the recorded image is frozen and recorded by flashlight. The moment of activation of the flashlight determines which image content has been detected on the camera.

In order to be able to hit an exactly defined point on the print web, an auxiliary means must be installed creating a reference to a point on the print web.

Usually, webs are transported by rollers, so that these rollers as starting points allow an assignment to a particular position of the material web. In the case of an application in a printing machine or in a machine processing a pattern produced by printing, in particular the printing plate is a very good reference to the printed motive. Advantage of this is usually made by attaching an encoder whose pulses have a good reference to the web to such a cylinder.

A disadvantage of this is that as a result of slip and expansion of the material web this reference shifts, so that the object of triggering as exactly as one point is no longer achieved.

This situation may be improved by printing a block mark as well, which is then scanned for the purpose of synchronization by means of a common spot-scanning light scanner. However, a disadvantage of this improved solution is that the mark has to be of considerable size (in particular width) so that it still can be reliably recognized even in the case of lateral web travel variations. Printing such a mark requires additional amounts of paper on which the mark is arranged.

Another improvement makes use of an ID code mark that is recognized as a result of its predetermined pattern and can be used as a fixed point on the web. Although this allows the mark to be placed on an environment of printing motives, this bears still the disadvantage that the mark has to be of relatively large size to be found in the case of lateral courses of the web.

When using a sensor technology working in a similar way as a camera it is necessary to detect the entire image with one shoot. A result of this is that for longer codes either several images have to be taken and processed or that an adjustment has to be carried out via a zoom function, which in turn results in considerable costs.

What is needed, therefore, is a method or device for controlling objects in synchronicity with a moving material web which allows controlling to be carried out with high accuracy but involving comparatively low effort.

### SUMMARY

In response to these and other problems, there is disclosed a method for controlling objects in synchronicity with a moving material web, the method comprising: detecting differences in brightness and/or color contrast of mark patterns applied to the material web one behind the other in the web travel direction for the purpose of identifying the mark pattern; scanning the mark patterns by at least two line sensors arranged one behind the other and consisting of several discrete sensor elements located next to each other; comparing the detected mark pattern applied to the material web to a predetermined mark pattern; and emitting a control signal according to the result of the comparison carried out.

In other aspects, there is disclosed a device for controlling objects in synchronicity with a moving material web. In certain aspects, the device may comprise: an illumination device for illumination a material web image area to be measured, the web image area comprising at least one mark pattern which applied to the material web and comprises at least two mark elements arranged one behind the other in a direction of web travel; a sensor arrangement for scanning the material web image area, the arrangement comprising at least two sensor elements arranged one behind the other in the direction of web travel; and a signal processing means in communication with the sensor arrangement for generating an output signal.

These and other features, and advantages, will be more clearly understood from the following detailed description taken in conjunction with the accompanying drawing. It is important to note the drawing is not intended to represent the only aspect of the invention.

### BRIEF DESCRIPTION OF THE DRAWING

FIG. 1. illustrates a schematically simplified block diagram of a device incorporating one or more aspects of the present invention.

### DETAILED DESCRIPTION

Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry or mechanisms used to control the rotation of the various elements described herein are omitted, as such control circuits are within the skills of persons of ordinary skill in the relevant art.

According to the principles of the present invention, a novel method and a novel device are provided for recording and evaluating signals which originate from a small mark and can be recorded with a fixed focal length and constant representation characteristics.

On the material web, in particular the print web, a printing cylinder periodically (usually once per cylinder rotation) prints a mark pattern (code mark) consisting of bars and spaces having different dimensions. The inventive device is arranged above the track in which this mark pattern is printed.

According to the inventive method, the mark pattern is detected and in the subsequent evaluation process an identification of the marks is achieved sufficiently fast for the subsequent process.

This is achieved by using a respective sensor means comprising at least two cells arranged one behind the other at a very short distance, a differential signal of intensities being generated between two sensor elements arranged one behind the other of the one and the other line.

This embodiment is advantageous insofar as the influence of brightness fluctuations, for example caused by changes in the ambient light, as well as of the base on signal generation is reduced considerably.

The formation of the output signals practically constitutes a local differentiation of the gray scale series, by which a signal peak is formed only at the brightness transitions. Via a threshold operation all signals below a defined level are cut off, so that only significant bright/dark transitions are marked.

The distances between the bright/dark transitions are put into relation with respective known distances from an ID code mark and directly compared to a ratio determined in advance.

In this way, as a result of the useful bright/dark transitions resulting from the ID code mark a sequence of ratios is formed representing the pattern code in the case of equality. In the case of sufficient agreement, an output signal is then triggered. This generation of an output signal occurs if the pattern in question has been recognized by at least one pair of sensors.

In one aspect of the inventive device, the device may comprise a measuring head provided with an illumination device, a cell sensor element constituting a double line of photodiodes in which both cells are arranged parallel to one another and perpendicular to the direction of movement, a computing unit with a memory evaluating the signals of the two photodiode lines at high speed and an output emitting a signal if it has been detected that the current code and pattern match.

This signal is synchronous to the web with high accuracy and can be used for controlling, for example of image recording of a video camera.

The code mark consists of bars of alternating brightness (alternatively, alternating colors may be provided that are perceived by the sensor arrangement as change in brightness) and is a pre-known pattern of bright/dark arrangements and thus of bright/dark transitions. Seen in the travel direction of the web, the provided bars are located one behind the other and thus pass beneath the sensor arrangement when the web moves.

Accordingly, they create a change in brightness in the sensor elements they pass.

As the controlling according to the inventive method or inventive device, respectively, must be carried out permanently in the case of a traveling web that is also printed with other printing motives, a computing unit structure is provided, which practically carries out the evaluation continuously and emits the output signal with only a very short delay amounting to less than 6 μs.

For this purpose, the computing unit can be constructed in such a way that the comparison process is carried out concurrently for all sensor elements of the sensor arrangement and that the output signal is thus generated almost immediately as soon as coincidence has been reached in one track.

For lower requirements with regard to delay up to recognition of the pattern, a computing unit and a method can also be chosen in which received signals are first stored temporarily and then processed one after the other. If CCD line sensors are used, this process part can be developed in such a way that during parallel read-out of the lines this difference value is formed immediately and the process then continues as described above.

Similarly, with a mixed mode of operation a limited parallel processing with temporary storage of subareas from the lines is possible if the accepted delay time allows this.

In the inventive method a further method step has been added according to which the signal generated in a preceding method step is not processed further if it is below a defined threshold.

A sensor element, comprising a number of individual sensors, can be used in the method of the invention.

In certain aspects of the inventive method, the distance between at least two preceding signals can be used as standard distance. The distance between two arbitrarily selected distances from the signal sequence is selected as standard distance.

Alternatively, it is possible to form the standard distance from a pulse sequence originating from a pulse generator that is driven in synchronicity with the web.

As a further alternative it is also possible that the standard distance is calculated from the known speed of movement of the material web and the known geometrical length of the code pattern.

In certain aspects of the inventive device, a constant light source ensuring sufficient illumination of the area of interest can be provided as illumination device.

Another advantageous embodiment of the illumination device is to use an LED illumination. Such a source consists of discrete light emission surfaces. This embodiment can be used to compensate other effects affecting the distribution of brightness on the sensor, e.g. vignetting of an optical device. This in turn can be done by triggering the luminescent diodes with respectively different currents, so that individual diodes are illuminated with different intensity and thus cause a non-homogeneous illumination on the object to be measured but whose distribution is developed exactly in such a way that, superimposed with the vignetting of the objective, it generates a uniform signal on the sensor. The same can also be achieved by arranging the light emitting elements in a different surface density (diodes per surface unit) or at a different distance from the measuring field adapted to the situation.

The passing object, in particular the material web, is reproduced in an advantageous way via an optical device onto the sensor plane. The arrangement of the light source and of the sensor arrangement is determined by on which type of base (reflective, transparent, remittent . . . ) the mark patterns or the code mark have been printed and can make use of different principles of illumination such as dark field illumination or bright field illumination.

A particularly advantageous development is present if the computing unit is integrated with the measuring head in such a way that such a unit only requires a voltage feed as well as an output line and, if need be, a bus interface for communication.

In the embodiment described above, the mark pattern to be detected can be transferred from another external computer system that is also provided with a same bus interface via an integrated bus system, for example. This allows different codes adapted to the situation to be recognized by the system.

With the inventive method and the inventive device described above it is basically also possible to evaluate codes of arbitrary length without the need of detecting a code completely and concurrently.

Furthermore, compared to common methods and according to certain aspects of the invention, it is possible to recognize small ID code marks or mark patterns, respectively, even if the objective passes a sensor at different sites as a result of lateral method-caused movements. Undesirable effects during the recognition, caused by fluctuations in illumination or fluctuations in the base, can be eliminated from the gathering of measured values to a large extent with the inventive method, so that the way of working can be considerably improved in contrast to common methods exclusively based on gray scale values. The inventive method is indifferent to quivering of the material web, which shows itself both as fluctuations in brightness and changes in the size of the image, to a large extent.

Furthermore, the inventive method and the inventive device allow an embodiment that is capable of a real-time recognition process.

Furthermore, the inventive device is provided with sensor elements arranged in an angle of >0° relative to the web travel direction.

Preferably, the angle between web travel direction and the sensor elements is around 90°.

Furthermore, according to the invention it is possible that the sensor cells, in which the sensor elements are arranged, are arranged parallel.

Furthermore, it is also possible that the sensor lines are integrated in a sensor.

It is also possible to provide an interface that conveys the predetermined pulse sequence to a computing unit. The computing unit may comprise a field-programmable logic unit (FPGA unit) containing all operations.

Furthermore, in certain aspects of inventive device the individual sensor elements may consist of lines containing not more than 128 sensor elements. The sensor elements themselves may comprise a number of individual sensors. In some embodiments, two CCD cells (charge coupled devices) may be provided as sensor elements.

Alternatively, it is possible that as sensor elements a CMOS surface sensor is provided of which at least selected two lines are intended for evaluation.

In a further embodiment, a known hardware structure is integrated in the sensor element for two lines each.

Furthermore, the inventive device may be constructed in such a way that the light-emitting elements are triggered individually such that the power of light emitted compensates known local non-homogeneities caused by other components or elements.

The arrangement of the light-emitting elements may be selected such that it compensates known local non-homogeneities caused by other components or elements by a different density of arrangement.

In another embodiment, it can be provided that the arrangement of the light-emitting elements is selected such that the different distance of the light-emitting elements from the illuminated surface makes it suitable for compensating known local non-homogeneities caused by other components or elements.

The illumination device may generate a streak of light parallel to the arrangement of the sensor lines.

Furthermore, it is possible that an optical arrangement is provided between the sensor arrangement and the material web.

In another embodiment a means for signal pre-processing can be arranged between the sensor arrangement and the computing unit.

Finally, it is basically possible that the signal processing means of the inventive device is provided with a controller for controlling the computing unit, the illumination control means and the interface.

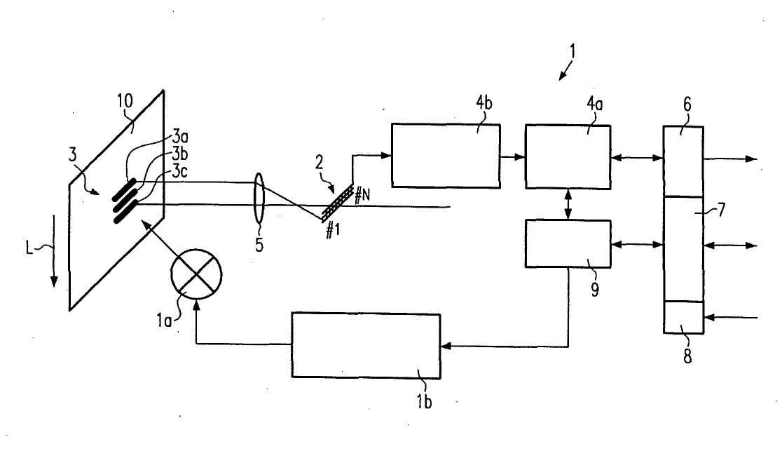

Turning now to FIG. 1, there is presented a schematically simplified block diagram of an inventive device 1. In this illustrative embodiment, the device 1 comprises an illumination device 1a connected to an illumination control 1b. The Illumination device 1a serves to illuminate a material web area of a material web 10 to be measured. As is illustrated by the FIG. 1, the image area in the example is provided with a mark pattern 3 consisting of three mark elements 3a, 3b and 3c arranged one behind the other in the web travel direction L. In other embodiments, it would also be also possible to provide only two mark elements or a greater number of these elements.

The inventive device 1 further comprises a signal processing means which comprises a computing unit 4a, an interface 7 as well as a controller or control device 9 in the embodiment shown. An optical device 5 may be arranged between material web 10 and a sensor arrangement 2 which may be designed as line sensor element as illustrated in this example embodiment. A means for signal pre-processing 4b may be arranged between sensor arrangement 2 and computing unit 4a is also illustrated.

Furthermore, the computing unit 4a may be coupled by way of interrelation to an output (trigger) 6 and to controller 9. The controller 9 in turn is coupled to means 1b for illumination control as well as to interface 7. Finally, inventive device 1 comprises a voltage feed 8. The embodiment of inventive device 1 shown in the figure may serve to carry out the method described above for controlling objects in synchronicity with moving material web 10 by means of a comparison of mark patterns 3 located on material web 10 to a predetermined mark pattern.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

The abstract of the disclosure is provided for the sole reason of complying with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

1. A method for controlling objects in synchronicity with a moving material web, the method comprising:
detecting differences in brightness and/or color contrast of mark patterns applied to the material web one behind the other in the web travel direction for the purpose of identifying the mark pattern;
scanning the mark patterns by at least two sequential line sensors, wherein each line sensor comprises several discrete sensor elements located adjacent to each other;
comparing the detected mark pattern applied to the material web to a predetermined mark pattern; and
emitting a control signal according to the result of the comparison carried out.

2. The method of claim 1, further comprising: forming a difference from the measured values of the two sequential line sensors for each pair of line sensors, and recording a differentiation of an intensity profile from one line sensor.

3. The method of claim 2, in which the distances between remaining pulse-shaped signals for each signal sequence formed of two line sensors is put into a relation with a standard distance, so that for each signal sequence a sequence of distance ratios is produced.

4. The method of claim 3 in which the sequences of distance ratios are compared to those for the known mark pattern.

5. The method of claim 4, in which for the case that for at least one ratio sequence, an agreement with the known pattern is recognized an output signal is set.

6. The method of claim 1, further comprising finding at least two reversal points from a signal course; and forming an output signal that changes by a minimum amount at the reversal point of its amplitude.

7. The method of claim 3, in which a distance between at least two preceding signals is used as standard distance.

8. The method of claim 1, further comprising forming a threshold from a histogram of the incoming measured values, the histogram being attained via a revolution of a printing plate cylinder or an impression with known impression size and in which the threshold differs from the brightness value of the base by about 10% or 25%, respectively.

9. The method of claim 5, in which the degree of agreement is predetermined by tolerance values.

10. The method of claim 1, further comprising:
detecting information concerning the absolute size of at least a part of the mark pattern and the speed of the moving web;
calculating as areas the absolute size of the mark patterns measured or of parts showing differences in contrast from the web speed and the measured distance ratios, and
comparing the absolute size to the known size of the mark pattern or of a part thereof and in which in the case of non-agreement no output signal is set.

11. A device for controlling objects in synchronicity with a moving material web, comprising:
an illumination device for illumination a material web image area to be measured, the web image area comprising at least one mark pattern which applied to the material web and comprises at least two mark elements arranged one behind the other in a direction of web travel;
a sensor arrangement for scanning the material web image area, the arrangement comprising at least two sensor elements arranged one behind the other in the direction of web travel; and
a signal processing means in communication with the sensor arrangement for generating an output signal.

12. The device of claim 11, wherein the signal processing means comprises a computing unit for differentiation of the signal arriving from each sensor element and for subsequent standardization of the resulting ratio sequence, the computing unit being designed in such a way that it compares this ratio sequence to a predetermined pulse sequence and emits an output signal via signal output in the case of agreement.

13. The device of claim 11, wherein the illumination device is designed as a continuous device and comprises elements emitting light individually for compensation of local non-homogeneities of the illumination.

14. The device of claim 11, wherein the illumination device further comprises an illumination control device carrying out a control of brightness by detecting the maximum values of the intensity profile and controlling brightness in such a way that the sensor arrangement can be operated in all its effective elements below a saturation limit.
